(19) United States
(12) Patent Application Publication
(10) Pub. No.: US 2021/0142390 A1
(43) Pub. Date: May 13, 2021

(54) FREIGHT SHIPMENT ESTIMATION SYSTEM

(71) Applicant: International Business Machines Corporation, Armonk, NY (US)

(72) Inventors: Subil Mathew Abraham, Lewisville, TX (US); Vikram Rengarajan, Irving, TX (US)

(21) Appl. No.: 16/678,504

(22) Filed: Nov. 8, 2019

(51) Int. Cl. G06Q 30/06; G06Q 10/08; G06N 20/00; G06F 3/0482

(52) U.S. Cl. CPC G06Q 30/0633; G06F 3/0482; G06N 20/00; G06Q 10/08345

(57) ABSTRACT

Provided is a method, a system, and a computer program product for determining estimated shipment options for an item captured in an image. The method includes initiating, via graphical user interface of a mobile computing device, a shipment order including order details for a user. The method further includes capturing, via a camera integrated into the mobile computing device, at least one image of an item to be shipped. The image can include multiple items to be shipped. The method also includes generating an insight related to the item by analyzing the image, transmitting the insight, the order details, and the least one image to a server. Freight service providers can analyze the information received at the server to determine a shipment option for the item. The method further includes receiving a shipment option from the server and providing the shipment option for the item to the user.

### BACKGROUND

The present disclosure relates to freight shipment, and more specifically, to performing a cognitive analysis on freight to provide various freight shipment options.

Freight shipment is the process of transporting commodities, products, merchandise, and cargo. Freight service providers utilize various modes of transportation to deliver goods and items to their destination. These modes of transportation include ground transportation, ship transportation, air transportation, and any combination thereof. Typically, freight service providers handle the logistics behind organizing the modes of transportation of goods from one location to another. Freight service providers typically consider the weight and dimensions of a good, or item, when determining the cost to ship the item.

### SUMMARY

Embodiments of the present disclosure include a computer-implemented method for determining estimated shipment options for an item captured in an image. The computer-implemented method includes initiating, via graphical user interface of a mobile computing device, a shipment order including order details for a user. The computer-implemented method further includes capturing, via a camera integrated into the mobile computing device, at least one image of an item to be shipped. The image can include multiple items to be shipped if requested by a user. The computer-implemented method also includes generating an insight related to the item by analyzing the image. The computer-implemented method further includes transmitting the insight, the order details, and the least one image to a server. Freight service providers can analyze the information received at the server to determine a shipment option for the item. The computer-implemented method further includes receiving a shipment option from the server and providing the shipment option for the item to the user.

Further embodiments are directed to a computer program product for determining estimated shipping options for an item captured in an image, which can include a computer readable storage medium having program instructions embodied therewith, the program instructions executable by a processor to cause the processor to perform a method. The method includes initiating, via graphical user interface of a mobile computing device, a shipment order including order details for a user. The method further includes capturing, via a camera integrated into the mobile computing device, at least one image of an item to be shipped. The image can include multiple items to be shipped. The method also includes generating an insight related to the item by analyzing the image. The method further includes transmitting the insight, the order details, and the least one image to a server. Freight service providers can analyze the information received at the server to determine a shipment option for the item. The method further includes receiving a shipment option from the server and providing the shipment option for the item to the user.

Additional embodiments are directed to a shipment estimation system for determining estimated shipping options for an item captured in an image, including at least one processing component and at least one memory component. The system also includes an image enhancer configured to enhance an image captured by a camera communicatively coupled to the system. The system also includes a segmentation component configured to parse out and segment an item captured in the image and an insight generation system configured to generate insights on the item to be shipped. The insights include various characteristics related to the item. The system further includes a dimension estimator configured to determine dimensions related to the item and a weight estimator configured to determine a weight related to the item.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a shipment estimation system, in accordance with embodiments of the present disclosure.

FIGS. 2A-2F illustrate an example of a shipment estimation system, in accordance with embodiments of the present disclosure.

FIG. 3 is a flow chart of an item shipment process, in accordance with embodiments of the present disclosure.

FIG. 4 is a high-level block diagram illustrating an example computer system that may be used in implementing one or more of the methods, tools, and modules, and any related functions, described herein, in accordance with embodiments of the present disclosure.

FIG. 5 depicts a cloud computing environment, in accordance with embodiments of the present disclosure.

FIG. 6 depicts abstraction model layers, in accordance with embodiments of the present disclosure.

While the present disclosure is amenable to various modifications and alternative forms, specifics thereof have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numeral are used to designate like parts in the accompanying drawings.

### DETAILED DESCRIPTION

The present disclosure relates to freight shipment, and more specifically, to performing a cognitive analysis on freight to provide various freight shipment options. While the present disclosure is not necessarily limited to such application, various aspects of the disclosure may be appreciated through a discussion of various examples using this context.

Individual customers of the freight and shipping industry have limited options in regard to the transportation and pricing of an item they want to ship. Typically, individuals must go through a manual process of transporting the item they wish to ship to the nearest shipment center of a freight service provider. Freight service providers, such as UPS® (a trademarked product of United Parcel Service of America, Inc. for providing transportation of goods and services) and FedEx® (a trademarked product of FedEx Corporation for providing logistics services), then provide customers with services for transporting the item from the shipment center to a desired destination.

Additionally, the pricing structure set by freight service providers evaluates a multitude of factors to determine the cost to the customer. Pricing can be determined from factors such as transit time, mode of transportation, destination, commodity type, as well as the type of item being shipped. Many of the factors, such as mode of transportation, cannot be determined by the customer. This prevents the customer from being able to choose how their item is handled or transported to its destination.

From the freight service provider perspective, wastage can become an issue if goods are transported in a logistically inefficient manner. Wastage can occur when vehicles transporting goods to their destination are not filled to capacity which can become costly. Currently, freight service providers are limited tools that lack automation in determining logistics prior to accepting shipment.

Embodiments of the present disclosure may overcome the above, and other problems, by implementing a shipment estimation system on a mobile computing device for customers to use when shipping items. The shipment estimation system can be configured to initiate new shipment order for a customer wishing to ship an item. The shipment estimation system can capture an image of the item to be shipped. The image can then be analyzed to generate insights on the item that may be material to shipping the item. Those insights can be transmitted to a server accessible to freight service providers that can provide shipping estimates based on the insights generated. The estimates can then be provided to the customer for selection.

More specifically, the shipment estimation system, described herein can operate on a mobile platform, such as a mobile computing device. In other words, a customer using a mobile computing device can utilize the shipment estimation system to select shipment options for items they wish to ship. Using the camera functionality of a mobile computing device, the shipment estimation system can determine the dimensions, the density, the weight, and identification of an item a customer would like shipped.

By way of example, an individual wishing to ship an item, such as a chair, can initiate the shipment estimation system via a graphical user interface (GUI) displayed on their mobile computing device. Once initiated, the individual can input information such as their name, address, phone number, destination location, and the like. Using the camera on their mobile computing device, the individual can take at least one image of the chair to allow the shipment estimation system to generate insights on the chair. The insights generated can vary depending on the item sent, but in some embodiments, the insights generated are the weight of the item, the dimensions of the item, and the identification of the item (e.g., a chair). Those insights can be uploaded to a server where freight service providers can determine a shipping estimate for the item. The estimates can then be transmitted back to the mobile computing device and provided to the individual by displaying the estimates on the GUI for the individual to choose from.

In some embodiments, the shipment estimation system is used to generate multiple shipments for multiple items detected in an image taken. For example, an individual wishing to ship items, such as a table and a chair, can initiate a shipment request similar to the example described above. Using the camera on their mobile computing device, the individual can take at least one image of the table and chair. The shipment estimation system can segment the image to parse out the table and chair. Insights and shipping estimates can be generated for each of the items, respectively.

In some embodiments, the shipment estimation system combines multiple items detected in an image for one shipment. For example, an individual wishing to ship items, such as a table and a chair, can initiate a shipment request similar to the examples described above. Using the camera on their mobile computing device, the individual can take at least one image of the table and chair. The shipment estimation system can segment the image to parse out the table and chair. Insights can be generated for both items and one shipment estimate can be generated for both items.

Embodiments of the present disclosure include a distributed ledger, such as a blockchain hyperledger. The shipment estimation system can upload the item information to a distributed ledger that can then be accessed by freight service providers as well as by recipients. The freight service providers and the recipients can access the distributed ledger and verify the item that they received matches the information stored on the distributed ledger.

For example, if an individual uses the shipment estimation system to ship a chair to a recipient, the chair information, such as the insights, weight, and various characteristics including spectroscopic properties can be uploaded to a distributed ledger. Once the recipient receives the chair, the recipient can then utilize the shipment estimation system to generate a second insight, weight, and characteristics. That information can then be uploaded to distributed ledger and compared with the information the individual uploaded. A determination can be made as to whether or not the two sets of information correspond with one another. A validation response can be sent from the server upon a determination that the second insight corresponds with the insight.

In some embodiments, the shipment estimation system provides a distributed ledger to freight service providers. The freight service providers, prior to, or upon acceptance of an item for shipment, can utilize the shipment estimation system to verify the item being shipped is the same item that an individual used to generate a shipment estimate. For example, a freight service provider can use the shipment estimation system to take an image of the item upon pick up. Insights, dimensions, weight, and other characteristics of the item can be generated and uploaded to a distributed ledger. A determination can be made as to whether or not the two sets of information correspond with one another.

Embodiments of the present disclosure include implementing augmented reality techniques to identify objects within an image. Augmented reality allows for objects in the real-world to be enhanced by computer-generated perceptual information. The augmented reality techniques can include computer vision, image calibration, visual coherence, situated visualization, 3D modeling and annotation, navigation, and the like. Utilizing these techniques, the shipment estimation system can identify objects and calculate distances within an image. The distances and identity of objects can be used to determine various characteristics of items needed for shipment. These characteristics can include size, shape, height, length, width, and the like.

Embodiments of the present disclosure include a machine learning model. The machine learning model can receive inputs, such as the insights generated to produce a generalized output. The insights can include the dimensions, the identification, and the weight of an item. Those insights can then be inputted as features for the machine learning model to analyze and produce an output. The generalized output can include the density of the item, shipment estimations from prospective freight service providers, additional characteristics of the item, and the like.

Additionally, freight service providers can receive insights of items potential customers wish to ship. The freight service providers can analyze those insights, such as the weight, dimension, and characteristics and perform logistical analysis of those insight to provide an estimate on providing a shipping service for that item.

In some embodiment, the shipment option provided to a user is segmented into stages of shipment. At times, freight service providers utilize multiple modes of transportation to ship an item to its destination. For example, a freight service provider may use ground shipping and air shipping to get an item to a destination. The stages of shipment can be defined as a different mode of transportation during the shipment process. A user can select which mode of transportation they wish to use for each stage that is required for transporting the item that is shipped.

It is to be understood that the aforementioned advantages are example advantages and should be not construed as limited. Embodiments of the present disclosure can contain all, some, or none of the aforementioned advantages while remaining within the spirit and scope of the present disclosure.

FIG. 1 is a block diagram illustrating a shipment estimation system 100, in accordance with embodiments of the present disclosure. The shipment estimation system 100 includes an image enhancer 110, a segmentation component 115, an insight generation system 120, a dimension estimator 130, and a weight estimator 140. The insight generation system 120 includes a machine learning model 122, an object identifier 124, and a position analyzer 126.

The image enhancer 110 is a component of the shipment estimation system 100 configured to enhance images of shipment items, in accordance with embodiments of the present disclosure. Using known image enhancement techniques, the image enhancer 110 can suppress any unwanted distortions, or noise, while also enhancing the image features to produce accurate results. In some embodiments, digital and spectral filters are implemented to enhance and sharpen the image taken.

The segmentation component 115 is a component of the shipment estimation system 100 configured to segment items identified in images, in accordance with embodiments of the present disclosure. The segmentation component 115 can segment the image to identify and parse out the item being shipped from the rest of the image. For example, an image can include several items, people, animals, and various other objects. The segmentation component 115 can identify objects and items not designated for shipping and disregard them from the analysis. In some embodiments, the segmentation component 115 identifies more than one item for shipment within the image. The segmentation component 114 can identify and parse out more than one item individually. Each item identified for shipping can then be used to analysis with the rest of the unneeded information within the image being disregarded.

The insight generation system 120 is a component of the shipment estimation system 100 configured to generate insights for items to be shipped, in accordance with embodiments of the present disclosure. The insight generation system can provide machine learning analysis, computer vision techniques, augmented reality techniques, positional awareness techniques, and the like. These features and techniques can be used by the dimension estimator 130 and weight estimator 140 to perform their computations and analysis.

The machine learning model 122 is a component of the insight generation system 120 configured to provide possible shipments for items captured in an image, in accordance with embodiments of the present disclosure. For example, the machine learning model 122 can perform predictive analysis, pattern detection, image classification, as well other types of categorical classifications. The machine learning model 122 can employ different algorithmic methods to map and label the inputted data. For example, the machine learning model 122 can employ a perceptron, a Naïve Bayes, a decision tree, a logistic regression, a k-nearest neighbor, a neural network, a support vector machine, or any other type of algorithm capable of classification.

The machine learning model 122 is further configured to provide a prediction probability for each label predicted. For example, if the machine learning model predicts a shipment estimate for a desk, that prediction is accompanied with a prediction probability, or confidence level, the machine learning model 122 has in providing that prediction. The prediction probability can be a percentage range from 0% to 100% depending on the confidence of the classifier. It should be noted that other forms of prediction probability can also show the confidence level of a predicted label by a given classifier. As the machine learning model 122 is trained, its prediction probabilities can also increase with each training iteration. The machine learning model 122 can go through several training iterations until the machine learning model 122 reaches a prediction probability threshold that is satisfactory for the task given to the model.

The machine learning model 122 can operate on a Bhattacharyya distance principle. The Bhattacharyya distance measures the similarity of two probability distributions. This can be used to provide feature extraction, selection, and processing of the image. Using the Bhattacharyya distance principle, a threshold for the similarities between the item in an image and a possible shipment option for that item can be set. If the similarity exceeds the threshold, then the shipment option can be selected for the item as a possible means for shipment.

The machine learning model 122 is further configured to provide a density for items captured in an image. The machine learning model 122 can input features such as length, width, height, identity of item, to output a generalized density. For example, the machine learning model 122 can output a density of a wooden coffee table based on the insights generated related to the coffee table.

The object identifier 124 is a component of the insight generation system 120 configured to identify objects for shipment, in accordance with embodiments of the present disclosure. The object identifier 124 can utilize augmented reality techniques to identify objects and measure the distance of the objects within an image. In some embodiments, the object identifier 124 utilizes computer vision techniques to measure the distance of objects. The computer vision techniques can include multi-camera infrared tracking, simultaneous localization and mapping, marker tracking, and the like. For example, marker tracking allows for detection of four corners of a flat marker in an image. Information can be extrapolated from the marker to determine a position of the camera relative to the marker (e.g., item to be shipped). That known position of the camera can then be used to measure the distance of the item in relation to the camera.

For example, the object identifier 124 can utilize marker tracking to implement a pinhole camera model which describes a perspective projection of a 3D point in an object space to a 2D point in an image space. The distance of an object to a center of projection (e.g., a camera position) can be calculated using information obtained from the image.

The object identifier 124 is further configured to build a 3D model of the item to be shipped. The object identifier 124 can utilize various model datasets for known items in conjunction with known augmented reality techniques and tools to generate a 3D model of the item.

The position analyzer 126 is a component of the insight generation system 120 configured determine the positioning of a camera capturing an image of an item. In some embodiments, the position analyzer 126 utilizes a built in gyroscope to determine a pitch, yaw, and roll of a camera in relation to an item. The pitch can be described as the motion made by a device along a transverse axis. The yaw can be described as the motion made by a device along a vertical axis. The roll can be described as the motion made by a device along a longitudinal axis.

The dimension estimator 130 is a component of the shipment estimation system 100 configured to identify the dimensions of items captured in an image. The dimension estimator 130 can utilize the insight generation system 120 to determine the height, width, and length of items for shipment. In some embodiments, the dimension estimator 130 utilizes the object identifier 124 and the position analyzer 126 to determine a height of an item captured in an image. To determine the height of an object shorter than the height of the device taking the image, a device height measurement and a new height measurement can be used. A device height can be described as the height of a device (e.g., a mobile computing device) measured from the floor. The new height can be described as the height of a device taken in relation to the top of the object to be shipped. By subtracting the device height from the new height, the height of the object, or item, to be shipped can be determined. The object identifier 124 can be used to determine the distance measurement using techniques as described herein, and the position analyzer 126 can be used to determine the angle of the device.

In some embodiments, the device height is calculated by dividing the distance of the item by the tangent of the angle the device has in relation to the base of the object. For example, an image of an item to be shipped is taken. The object identifier 124 can implement an augmented reality technique, such as marker tracking, to determine that the distance of the item is 100 cm. The position analyzer 126 can utilize a built into gyroscope of the device taking the image to determine that the angle of the device in relation to the base of the item is 30°. Using the formula described above, the device height can be calculated at approximately 173 cm.

In some embodiments, the new height is calculated by dividing the distance of the item by the tangent of the angle the device has in relation to the top of the object. For example, an image of an item to be shipped is taken. The object identifier 124 can implement an augmented reality technique, such as marker tracking, to determine that the distance of the item is 100 cm. The position analyzer 126 can utilize a built into gyroscope of the device taking the image to determine that the angle of the device in relation to the top of the item is 45°. Using the formula described above, the new height can be calculated at approximately 100 cm. By combining both examples for device height and new height, the calculated height of the item can be determined to be approximately 73 cm.

In some embodiments, the dimension estimator 130 utilizes machine learning model 122, the object identifier 124, and the position analyzer 126 to determine the length and the width of an item captured in an image. The object identifier 124 can implement various augmented reality techniques to determine height, width, and length estimates. For example, known 3D modeling techniques (e.g., subdivision/box, contour/edge, spline/NURBS, image-based modeling, etc.) can provide estimates for the height, width, and length of generated models. In some embodiments, the dimension estimator 130 uses augmented reality services, such as Apple® (a trademarked product of Apple Inc. for providing computers, computer software, and computer peripherals) ARKit, and Google® (a trademarked product of Google LLC for providing Internet-related services and products) ARCore, to generate estimates for the height, width, and length of an item captured in an image.

The dimension estimator 130 can determine a shipment width by dividing a calculated height of an item by the estimated height and then multiplying that by the estimated width. A shipment length can be determined by dividing a calculated height of an item by the estimated height and then multiplying that by the estimated length. The calculated height, shipment width, and shipment length can then be used as dimensions for the item to be shipped.

The weight estimator 140 is a component of the shipment estimation system 100 configured to calculate a weight for an item to be shipped. The weight estimator is further configured to determine the density and volume of an item to calculate the weight of that item. In some embodiments, the weight estimator 140 utilizes a spectroscope to identify an attenuation coefficient and a mass coefficient of a material that the item is comprised of. A spectroscopic analysis using the attenuation coefficient and the mass coefficient can be used for absorption spectroscopy. The properties of light absorbed by different materials, or compounds, can be unique. Based on that principle, the properties of an item for shipment can be identified. A formula used to determine density, such as attenuation divided by mass attenuation, can be used by the weight estimator 140 to calculate the density.

In some embodiments, the weight estimator 140 utilizes the machine learning model 122 to determine a generalized density for the item to be shipped. The machine learning model 122 can be trained with numerous datasets of various kinds of materials with additional features such as dimension and relative density. The weight estimator 140 can provide the machine learning model 122 with features of the item such as height, width, length, as well as other known characteristics to generate a density for the item.

In some embodiments, the weight estimator 140 parses out different materials of an item to get a density for each of the materials. For example, a table may include metal legs with a wooden top. The metal will have a different density from the wood. The weight estimator 140 can separate out the material and can perform a density and weight analysis for each material.

In some embodiments, the weight estimator 140 utilizes the characteristics outputted by the machine learning model 122 and the dimensions determined by the dimension estimator 130 to determine the weight of an item to be shipped. The characteristics can include information such as the density and material of an item. The dimensions can be used to determine a volume for the item. The weight can then be determined by multiplying the density with the volume.

The camera 160 is a device configured to capture images of items and is communicatively coupled to the shipment estimation system 100. In some embodiments, the camera is built into within a mobile computing device operating the shipment estimation system 100. For example, the camera can be built into within a cellular telephone, a personal digital assistant (PDA), a smartphone, a laptop, a tablet, a notebook computer, a personal computer, a wearable device such as a smart watch, and the like.

The network 180 is a component communicatively coupled to the shipment estimation system 100 and configured to provide and distribute resources between computational devices. The network 180 can be implemented using any number of any suitable communications media. For example, the network 180 may be a wide area network (WAN), a local area network (LAN), the Internet, or an intranet.

In some embodiments, the network 180 may be a telecommunication network. The telecommunication network may include one or more cellular communication towers, which may be a fixed-location transceiver that wirelessly communicates directly with a mobile communication terminal (e.g., a mobile computing device operating the shipment estimation system 100). The wireless communications links may include, for example, shortwave, high frequency, ultra-high frequency, microwave, wireless fidelity (Wi-Fi), Bluetooth technology, global system for mobile communications (GSM), code division multiple access (CDMA), second-generation (2G), third-generation (3G), fourth-generation (4G), fifth-generation (5G), or any other wireless communication technology or standard to establish a wireless communications link.

FIGS. 2A-2F illustrates an example of a shipment estimation system 100, in accordance with embodiments of the present disclosure. FIGS. 2A-2F are sequential such that the circumstances depicted in FIG. 2A occur prior to the circumstances depicted in FIG. 2B, and so on. In the illustrated example, the shipment estimation system 100 is operating on a mobile computing device 210. For example, the shipment estimation system 100 can be running as an application installed on the mobile computing device 210. In some embodiments, the mobile computing device 210 is a wireless transmit/receive unit (WTRU). For example, the mobile computing device can be a cellular telephone, a personal digital assistant (PDA), a smartphone, a laptop, a tablet, a notebook computer, a personal computer, a wearable device such as a smart watch, and the like.

FIG. 2A illustrates the mobile computing device 210 displaying an example graphical user interface (GUI) 220 of the shipment estimation system 100. The GUI 220 is displaying an exemplary initial screen of shipment estimation system 100 where a user can select a new shipment 230 to begin utilizing various operations. Once a user selects a new shipment 230 and initializes a new order, the shipment estimation system 100 can proceed with gathering information.

FIG. 2B illustrates the mobile computing device 210 displaying a general information screen 240 on the GUI 220. The general information screen 240 can include fields such as origin of the item to be shipped, the destination the user wishes to send the item to, the name, the address, the phone number, email, payment method, additional information, and the like, of the user. The general information can be used to assist the shipment estimation system 100 in determining an appropriate shipment for the item. Once all the required information has been entered by a user, the user can proceed with the next operation by selecting a next button 248.

In some embodiments, a back button 244 is available to allow the user to return to the previous screen displayed by the GUI 220. In this instance, the back button 244 can return to the user to the initial screen of the shipment estimation system 100.

In some embodiments, the general information screen 240 is prepopulated using data from a pre-existing user profile. The user need not fill out the general information screen 240 if they have created a profile to be used in subsequent orders. For example, a user can create a profile containing their name, address, phone number, payment method, and the like that the shipment estimation system 100 can access and retrieve. The user can choose to change any of the information fields, or they can select the next button 248 to proceed to the next operation.

FIG. 2C illustrates a camera interface 250 displayed on the mobile computing device 210. The camera interface 250 displays a camera viewfinder 260 capturing an item 265 a user wishes to ship. The user can utilize a camera 160 (see FIG. 1) built into the mobile computing device 210 to capture an image of an item they wish to ship.

In some embodiments, the user utilizes the camera 160 to capture multiple items they wish to ship in one image. For example, the camera viewfinder 260 can display the item 265 as well as another item (not shown) and both items can be analyzed by the shipment estimation system 100 to generate shipments for each of the item. The shipment estimation system 100 can also generate one shipment for both the item 265 as well as the other item. While not shown it will be appreciated that the shipment estimation system 100 can capture and analyze multiple items within an image and embodiments of the present disclosure are not limited to a single item for shipment.

In some embodiments, the shipment estimation system 100 begins analyzing the item 265 prior to a user capturing an image of the item 265. For example, the shipment estimation system 100 can begin performing spectroscopic analysis on the item 265 to measure various properties of the item 265.

FIG. 2D illustrates an insight generated screen 270 displaying the insights generated for the item 265 by the shipment estimation system 100. The insight generated screen 270 can display insights such as item type, weight, dimensions, composition, and the like. As shown, the insights generated for the item 265 are that it is a coffee table and categorized as furniture. The weight of the coffee table is estimated at 36.5 lbs., and the estimated dimensions are 46.5″×30.75″×17.75″. The coffee table is estimated to be composed of wood. These insights can be used to determine an accurate shipment estimate for the item 265. The user can review the insights and proceed to the next operation by pressing the next button 248 if they wish to do so. However, if the user wishes for the shipment estimation system 100 to re-perform the insights analysis for the item, they can press the back button 244 and return to the previous operation (e.g., the image capture operation).

FIG. 2E illustrates a shipping options screen 280 displaying available shipment methods for the item 265. The shipment options displayed on the shipping option screen 280 can be generated based, at least partially on, the insights generated by the shipment estimation system 100. As shown, the user can select the type of shipment they wish to use for the item 265. The user can also select various combinations of modes of transportation if they wish to do so. For example, as shown, the user can select to ship the item 265 using road transportation and ship transportation. Once the user selects the shipment method of their choosing, they can proceed with finalizing their order by pressing the next button 248 or they can choose to return to the previous operation by pressing the back button 244.

FIG. 2F illustrates a receipt screen 290 displaying the receipt for the services selected by the user. In this example, the user selected two-day shipping by air for the item 265. Additionally, the user selected that the item be insured during transportation. While not shown, the receipt screen 290 can also display an order confirmation number, a tracking number if available, user information, origin and destination addresses, freight service provider information, and the like. The user can return to the initial screen of the shipment estimation system 100 by pressing the new order button 295 if they wish to proceed with another order.

FIG. 3 is a flow diagram illustrating a process 300 of generating a shipment estimate for an item to be shipped, in accordance with embodiments of the present disclosure. The process 300 may be performed by hardware, firmware, software executing on a processor, or a combination thereof. For example, any or all of the steps of the process 300 may be performed by one or more processors embedded in a mobile computing device.

A new shipment order is initiated for the shipment estimation system 100. This is illustrated at step 310. The shipment order can contain order details relating to a user. For example, the order details can include information such as a name, address, phone number, origin address, destination address, payment information, and the like, related to a user operating the shipment estimation system 100. In some embodiments, the user manually populates the order details via a general information screen. The general information screen can include fields that can assist the shipment estimation system 100 in providing an estimate to the user. In some embodiments, the user has a profile in which the shipment estimation system 100 can access to retrieve the order details.

A camera 160 integrated into a mobile computing device captures at least one image of an item to be shipped. This is illustrated at step 320. Using the camera 160 capabilities of the mobile computing device, the user can capture an image of an item they wish to ship. In some embodiments, the user captures multiple images of the item to be shipped. For example, the user can capture images of the item from multiple angles. The image enhancer 110 can enhance the image to allow for accurate analyzation of the item.

In some embodiments, the camera 160 captures multiple items to be shipped. The user can choose to ship multiple items either separately or together and can capture all of the items in at least one image. The segmentation component 115 can parse out the noise detected in the image and segment the items to be shipped. This allows the shipment estimation system 100 to conduct an analysis on each of the items the user wishes to ship.

Insights related to the item captured in the image are generated by the shipment estimation system 100. This is illustrated at step 330. The insights generated for the item can include the weight, dimensions, density, composition, item type, and the like. The dimension estimator 130 can generate dimensions for the item by accessing the insight generation system 120. For example, the dimension estimator can access the position analyzer 126 to determine a height of the item and the machine learning model 122 to determine the length and width of the item. The insights generated can vary and are not limited to the insights described herein. The insights can include any information that may assist the shipment estimation system 100 in determining shipment options for the item the user wishes to ship.

The insights generated by the shipment estimation system 100 are transmitted to a server. This is illustrated at step 340. The server can be accessed by freight service providers to allow them to analyze the insights and provide shipping quotes for the item to be shipped. In some embodiments, the insights are uploaded to a distributed ledger to allow for analysis and authentication for the item. In some embodiments, the shipment estimation system 100 includes predetermined shipment options. The shipment estimation system 100 can analyze the insights using the machine learning model 122 to select acceptable shipment options for the item to be shipped. For example, the shipment estimation system 100 can include predetermined shipment options for a coffee table with certain dimensions. The insights can be analyzed, and the predetermined shipment option can be provided to the user without the need of transmitting the insights to a server.

The shipment estimation system 100 receives shipment options from prospective freight service providers related to the item. This is illustrated at step 350. The freight service providers can provide various shipment options for the item to be shipped and transmit that information to the shipment estimation system 100. For example, a freight service provider can provide various shipment options such as options related to the various modes of transportation. The freight service providers can also provide shipment options for a combination of modes of transportation. For example, a freight service provider can provide a shipment option of road and air while also providing a different shipment option of just road transportation.

The shipment options related to the shipment item are displayed to the user for selection. This is illustrated at step 360. The shipment estimation system 100 can display the various shipment options to the user and arrange them by price, mode of transportation, duration, and the like. This allows the user the flexibility of selecting a shipment method of their choosing for the item they wish to ship.

Referring now to FIG. 4, shown is a high-level block diagram of an example computer system 400 (e.g., shipment estimation system 100, insight generation system 120) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 400 may comprise one or more processors 402, a memory 404, a terminal interface 412, a I/O (Input/Output) device interface 414, a storage interface 416, and a network interface 418, all of which may be communicatively coupled, directly or indirectly, for inter-component communication via a memory bus 403, a I/O bus 408, and an I/O bus interface 410.

The computer system 400 may contain one or more general-purpose programmable central processing units (CPUs) 402-1, 402-2, 402-3, and 402-N, herein generically referred to as the processor 402. In some embodiments, the computer system 400 may contain multiple processors typical of a relatively large system; however, in other embodiments the computer system 400 may alternatively be a single CPU system. Each processor 402 may execute instructions stored in the memory 404 and may include one or more levels of on-board cache.

The memory 404 may include computer system readable media in the form of volatile memory, such as random-access memory (RAM) 422 or cache memory 424. Computer system 400 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

Although the memory bus 403 is shown in FIG. 4 as a single bus structure providing a direct communication path among the processors 402, the memory 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 400 may, in some embodiments, contain multiple I/O bus interface units, multiple I/O buses, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 400. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (PDA) or cellular telephone 520-1, desktop computer 520-2, laptop computer 520-3, and/or automobile computer system 520-4 may communicate. Nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 520-1 to 520-4 shown in FIG. 5 are intended to be illustrative only and that computing nodes 10 and cloud computing environment 500 can communicate with any type of computerized device over any type of network and/or network addressable connection (e.g., using a web browser).

Referring now to FIG. 6, a set of functional abstraction layers provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include: mainframes 611; RISC (Reduced Instruction Set Computer) architecture based servers 612; servers 613; blade servers 614; storage devices 615; and networks and networking components 616. In some embodiments, software components include network application server software 617 and database software 618.

Virtualization layer 620 provides an abstraction layer from which the following examples of virtual entities may be provided: virtual servers 621; virtual storage 622; virtual networks 623, including virtual private networks; virtual applications and operating systems 624; and virtual clients 625.

In one example, management layer 630 may provide the functions described below. Resource provisioning 631 provides dynamic procurement of computing resources and other resources that are utilized to perform tasks within the cloud computing environment. Metering and Pricing 632 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 633 provides access to the cloud computing environment for consumers and system administrators. Service level management 634 provides cloud computing resource allocation and management such that required service levels are met. Service Level Agreement (SLA) planning and fulfillment 635 provide pre-arrangement for, and procurement of, cloud computing resources for which a future requirement is anticipated in accordance with an SLA.

Workloads layer 640 provides examples of functionality for which the cloud computing environment may be utilized. Examples of workloads and functions which may be provided from this layer include: mapping and navigation 641; software development and lifecycle management 642; virtual classroom education delivery 643; data analytics processing 644; transaction processing 645; and shipment estimation processing 646 (e.g., shipment estimation system 100).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method performed by a processor of a mobile computing device, the method comprising:
initiating, via a graphical user interface (GUI) of a mobile computing device, a new shipment order including order details for a user;
capturing, via a camera integrated into the mobile computing device, at least one image of an item to be shipped;
generating an insight related to the item by analyzing the at least one image;
transmitting the insight, the order details, and the at least one image to a server;
receiving a shipment option from the server; and
providing, via the GUI, the shipment option for the item to the user.

2. The computer-implemented method of claim 1, further comprising:
selecting the shipment option; and
receiving a receipt from a freight service provider.

3. The computer-implemented method of claim 1, wherein generating the insight comprises:
identifying a shipment item captured in the at least one image;
analyzing the at least one image to determine dimensions related to the item;
inputting the shipment item, and the dimensions, into a machine learning model as features; and
outputting a density by the machine learning model based on the features inputted.

4. The computer-implemented method of claim 1, wherein providing the shipment option comprises:
segmenting freight service providers into stages of shipment included in the shipment option; and
listing the freight service providers available to ship the item including pricing for each of the freight service providers.

5. The computer-implemented method of claim 1, further comprising:
capturing, via the camera integrated into the mobile computing device, a second image of the item;
generating a second insight related to the item by analyzing the second image;
transmitting the second insight and the second image to the server; and
receiving, from the server, a validation response upon a determination that the second insight corresponds with the insight.

6. The computer-implemented method of claim 1, further comprising:
capturing, via the camera integrated into the mobile computing device, a second image of a second item;
generating a second insight related to the second item by analyzing the second image; and
transmitting the second insight, the order details, and the second image to the server;
receiving a second shipment option from the server; and
providing, via the GUI, the second shipment option for the item and the second item to the user.

7. The computer-implemented method of claim 1, wherein transmitting the insight further comprises uploading the insight to a distributed ledger.

8. A computer program product comprising a computer readable medium having program instructions embodied therewith, the program instructions executable by a processor to cause the processor to perform a method comprising:
initiating, via a graphical user interface (GUI) of a mobile computing device, a new shipment order with order details for a user;
capturing, via a camera integrated into the mobile computing device, at least one image of an item to be shipped;
generating an insight related to the item by analyzing the at least one image;
transmitting the insight, the order details, and the at least one image to a server;
receiving a shipment option from the server; and
providing, via the GUI, the shipment option for the item to the user.

9. The computer program product of claim 8, further comprising:
selecting the shipment option; and
receiving a receipt from a freight service provider.

10. The computer program product of claim 8, wherein generating the insight comprises:
identifying a shipment item captured in the at least one image;
analyzing the at least one image to determine dimensions related to the item;
inputting the shipment item, and the dimensions, into a machine learning model as features; and
outputting a density by the machine learning model based on the features inputted.

11. The computer program product of claim 8, wherein providing the shipment option comprises:
segmenting freight service providers into stages of shipment included in the shipment option; and
listing the freight service providers available to ship the item including pricing for each of the freight service providers.

12. The computer program product of claim 8, further comprising:
capturing, via the camera integrated into the mobile computing device, a second image of the item;
generating a second insight related to the item by analyzing the second image;
transmitting the second insight and the second image to the server; and
receiving, from the server, a validation response upon a determination that the second insight corresponds with the insight.

13. The computer program product of claim 8, further comprising:
capturing, via the camera integrated into the mobile computing device, a second image of a second item;
generating a second insight related to the second item by analyzing the second image; and
transmitting the second insight, the order details, and the second image to the server;
receiving a second shipment option from the server; and
providing, via the GUI, the second shipment option for the item and the second item to the user.

14. A shipment estimation system comprising:
an image enhancer configured to enhance an image captured by a camera communicatively coupled to the shipment estimation system;
a segmentation component configured to parse out and segment an item captured in the image;
an insight generation system configured to generate insights on the item, wherein the insights include characteristics related to the item;
a dimension estimator configured to determine dimensions related to the item; and
a weight estimator configured to determine a weight related to the item.

15. The shipment estimation system of claim 14, wherein the insight generation system includes a machine learning model, an object identifier, and a position analyzer.

16. The shipment estimation system of claim 15, wherein the machine learning model is configured to output a density related to the item.

17. The shipment estimation system of claim 15, wherein the object identifier is configured to implement augmented reality techniques to determine an item type related to the item.

18. The shipment estimation system of claim 15, wherein the position analyzer is configured to utilize a gyroscope to determine a position of the camera.

19. The shipment estimation system of claim 14, wherein the insight generation system is further configured to upload the insights to a distributed ledger.

20. The shipment estimation system of claim 19, further configured to authenticate the item by comparing the insights uploaded to the distributed ledger with new insights generated.
